(19) United States
(12) Patent Application Publication
(10) Pub. No.: US 2016/0261507 A1
(43) Pub. Date: Sep. 8, 2016

(54) METHOD AND APPARATUS FOR CONTROLLING AND MANAGING FLOW

(71) Applicant: ELECTRONICS AND TELECOMMUNICATIONS RESEARCH INSTITUTE, Daejeon-si (KR)

(72) Inventors: Ji Young KWAK, Gwangju-si (KR); Sae Hoon KANG, Daejeon-si (KR); Yong Yoon SHIN, Sejong-si (KR)

(21) Appl. No.: 15/059,769

(22) Filed: Mar. 3, 2016

(30) Foreign Application Priority Data
Mar. 5, 2015 (KR) 10-2015-0031171

(51) Int. Cl. H04L 12/803; H04L 12/707; H04L 12/741; H04L 12/721; H04L 12/715

(52) U.S. Cl. CPC H04L 47/125; H04L 45/38; H04L 45/64; H04L 45/745; H04L 45/24

(57) ABSTRACT

A method and apparatus for controlling and managing a flow. The apparatus classifies a flow management space into a plurality of spaces, detects a heavy load-flow in the classified flow management space, and adjusts variably the flow management space due to a control traffic processing overhead, transmits the detected heavy load-flow according to a weight of each forwarding path through multi-path routing, and balances traffic.

### CROSS-REFERENCE TO RELATED APPLICATION(S)

This application claims the benefit under 35 U.S.C. §119(a) of Korean Patent Application No 10-2015-0031171, filed on Mar. 5, 2015, in the Korean Intellectual Property Office, the entire disclosure of which is incorporated herein by reference for all purposes.

### BACKGROUND

1. Field

The following description relates to a network management technology, and more specifically, to a technology for controlling and managing a flow in a network and a transmission technology therefor.

2. Description of the Related Art

Due to the trend of a cloud computing technology being developed, big data multimedia content being increased, and a big data analyzing technology being introduced, a data center is rapidly increasing. The amount of power a data center network consumes is constant regardless of a rate of use of network resources, which causes a demand for more operating expenses than the actual required expense. In addition, the most of the network resources are rarely used owing to a static method of selecting a path, whereas traffic is concentrated on a part of specific link resources, which results in the congestion. To solve these problems, a software-defined network (SDN) technology has appeared.

Due to a rapid development and dissemination of the internet, the network traffic evolves to a quality of service (hereinafter referred to as ‘QoS’) beyond the existing best effort service while the network traffic rapidly becomes large-scale. Various efforts for supporting the QoS for the internet service are made. However, making the traffic large-scale, and various applications appearing, which both are caused by a rapid increase of interact users, have made characteristics of the internet traffic more complex. Particularly, services for transferring large data files, such as peer-to-peer (P2P) and web hard, have a tendency to cause large data, as well as high traffic. Such a tendency was a factor causing a state in which a specific user alone takes a part of the entire network bandwidth for a specific duration. Such a flow causes a problem of unfairly using a network bandwidth in terms of management and services of internet traffic. Accordingly, since such the unfair use causes a flow control problem in terms of a bandwidth management and charging, an efficient management of an overload flow is one of the technical factors of network traffic to be necessarily supported.

### SUMMARY

Provided is a method and apparatus for controlling and managing a flow so as to increase a probability that a flow, causing a problem of unfairly using a network bandwidth, may be detected, and so as to balance a traffic load for the detected flow.

In one general aspect, a method of controlling and managing a flow includes: classifying a flow management space into a plurality of spaces, and managing the plurality of spaces; detecting a heavy load-flow in the classified flow management space, and adjusting variably a range of the classified flow management space to detect the heavy load-flow.

The classifying and the managing may include classifying the flow management space existing within a switch into a first space for managing the heavy load-flow, a second space for managing a general flow entry, and an overlapping space, in which the first and second spaces are overlapped, wherein each flow entry is moved between each space according to a flow cache lookup. Here, the classifying and the managing may include: managing a heavy load-flow entry in the first space excluding the overlapping space; managing a candidate heavy load-flow entry in the overlapping space; and managing the general flow entry in the second space.

The detecting of the heavy load-flow may include: in response to a new flow coming in to the switch, storing an entry of the incoming flow in the second space of the flow management space; in response to a count value of the flow entry, stored in the second space, increasing to reach a predetermined threshold, determining the flow entry as the heavy load-flow entry and moving the flow entry from the second space to the first space; and checking whether the flow entry is a candidate heavy load-flow entry immediately before the flow entry leaves the overlapping space, where the first space and the second space overlap, after the flow entry gradually comes down to a bottom of the second space with new incoming flow entries being added, and in response to the flow entry being determined to be the candidate heavy load-flow entry, moving the flow entry to a top of the second space, and extending the entry management period.

The adjusting variably of the range may include adjusting variably a size of the flow management space according to a flow processing delay time or a flow processing rate with respect to the switch of the controller. The adjusting variably of the range may include adjusting a size of the flow management space according to a number of flow processing requests the switch transmits to the controller.

In another general aspect, a method of controlling and managing a flow includes: detecting a heavy load-flow; and transmitting the detected heavy load-flow according to a weight of each forwarding path through multi-path routing, and balancing traffic.

The balancing of the traffic may include: calculating the weight of each forwarding path for transmitting a flow with respect to the heavy load-flow; and transmitting the heavy load-flow according to a ratio of the calculated weight of each forwarding path through the multi-path routing.

The calculating of the weight may include calculating weights of forwarding paths based on a load ratio of each link forming the forwarding path.

The method may further include forming a group table for managing group information, related to a matching flow, for the multi-path routing, wherein each group table includes a set of group action buckets, each of which includes information on a weight that refers to a percentage of traffic buckets to be processed in a group unit, as well as information on an action set to be applied to the matching flow.

The method may further include: in response to a flow being transmitted to an output edge switch through the multi-path routing, receiving a control message, which includes load information of each path, from the output edge switch; and recalculating the weight of each path by using the received load information, and transmitting a control message to output edge switches, in which the weight of each path is recalculated, so as to update the weight of the group table. The load information of each path may be updated to a maximum value among loads of each link forming a path by switches existing within the forwarding path.

In another general aspect, an apparatus for controlling and managing a flow includes a processor, which comprises a flow detector to classify a flow management space into a plurality of spaces, detect a heavy load-flow in the classified flow management space, and adjust variably the flow management space.

The flow detector may classify the flow management space existing within a switch into a first space for managing the heavy load-flow, a second space for managing a general flow entry, and an overlapping space, in which the first and second spaces are overlapped, wherein each flow entry is moved between each space according to a flow cache lookup.

The flow detector may manage a heavy load-flow entry in the first space excluding the overlapping space; manage a candidate heavy load-flow entry in the overlapping space; and manage the general flow entry in the second space.

The flow detector may adjust a size of the flow management space according to a flow processing delay time or a flow processing rate with respect to a switch of a controller, or according to a number of flow processing requests the switch transmits to the controller.

The processor further may include a flow transmitter to transmit the detected heavy load-flow according to a weight of each forwarding path through multi-path routing, and balance traffic.

The flow transmitter may calculate a weight of each forwarding path based on a load ratio of each forwarding path, and transmit the heavy load-flow according to a ratio of the calculated weight of each forwarding path through the multi-path routing.

The flow transmitter may form a group table for managing group information, related to a matching flow, for the multi-path routing, wherein each group table includes a set of group action buckets, each of which includes information on a weight that refers to a percentage of traffic buckets to be processed in a group unit, as well as information on an action set to be applied to the matching flow.

The processor may in response to a flow being transmitted to an output edge switch through the multi-path routing, receive a control message, which includes load information of each path, from the output edge switch; and recalculate a weight of each path by using the received load information, and transmitting a control message to output edge switches, in which the weight of each path is recalculated, so as to update the weight of the group table.

Other features and aspects may be apparent from the following detailed description, the drawings, and the claims.

### BRIEF DESCRIPTION OF THE DRAWINGS

FIG. 1 is a diagram illustrating a software-defined network (SDN) according to an exemplary embodiment.

FIG. 2 is a diagram illustrating an apparatus for controlling and managing a flow according to an exemplary embodiment.

FIG. 3 is a diagram illustrating a structure of a flow cache inside a switch, for description of a process for detecting a heavy load-flow.

FIG. 4 is a diagram illustrating an example of a flow classification according to a threshold.

FIG. 5 is a diagram illustrating a table structure for the description of a flow forwarding process for balancing a traffic load.

FIG. 6 is a diagram illustrating a network structure for the description of a process for updating a path weight.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

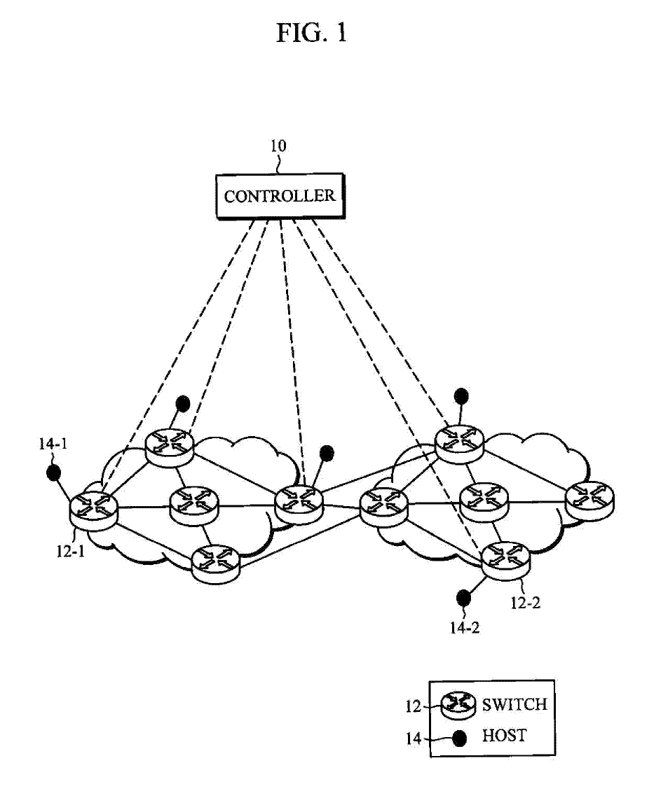

FIG. 1 is a diagram illustrating a software-defined network (SDN) according to an exemplary embodiment.

Referring to FIG. 1, a SDN includes a controller 10 and a switch 12. There may be a plurality of switches 12.

The switch 12 inquires every determination about the packet processing to the controller 10, which centrally controls the switch 12. A network having the above-mentioned characteristics is called ‘SDN’.

The switch 12 is managed by the controller 10. A series of packets flowing from a packet reception to a packet transmission refers to a flow, wherein the packet reception is performed by an edge switch on an input side 12-1 (hereinafter referred to as ‘input edge switch’), which is connected to a first host 14-1, and wherein the packet transmission is performed by an edge switch on an output side 12-2 (hereinafter referred to as ‘output edge switch’), which is connected to a second host 14-2. The flow may be defined by a particular application of OpenFlow architecture. Because of this point, the OpenFlow is one type of the SDNs.

A lot of control traffic is generated in an SDN environment, in which the entire network is managed by one controller 10 that is centrally managed. In addition, as a size of the network becomes bigger, the number of switches 12 required to be managed increases so that the control traffic is concentrated on the controller 10, which results in an excessive load. Moreover, since the size of memory is limited, e.g., ternary content-addressable memory (TCAM) being able to store a flow entry inside the switch 12, not all the flow entries, which are generated during a network operation, can be stored because of a limit to the management space. The method and apparatus for controlling and managing a flow according to an exemplary embodiment may manage flows, consistently generated, according to such a limit in space, and may detect and control not every flow but only particular flows, which are subjects to be managed. Accordingly, the method and apparatus therefor may effectively control the entire network by not generating a flow processing traffic above a hardware capacity of the controller 10.

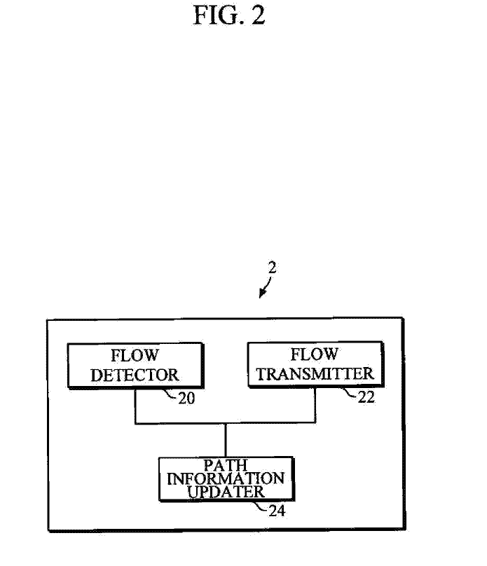

FIG. 2 is a diagram illustrating an apparatus for controlling and managing a flow according to an exemplary embodiment.

Referring to FIG. 2, an apparatus 2 for controlling and managing a flow includes a processor, which includes a flow detector 20, a flow transmitter 22, and a path information updater 24. The apparatus 2 in FIG. 2 is classified based on its function, each component of which may be positioned in a controller 10 or a switch 12, wherein some parts thereof may be positioned in the controller 10, and the other parts thereof may be positioned in the switch 12. Furthermore, one component may be divided into and positioned in the controller 10 and the switch 12.

For the load balancing of the entire network, the flow detector 20 classifies flows according to characteristics of the traffic and detects a heavy load-flow. The heavy load-flow refers to a network flow, which solely takes up a part of the entire bandwidth in a network link during a specific period of time and has an excessive number of bytes. The network flow shows a polarized form according to a packet size, wherein the heavy load-flow consumes the most of the link bandwidth, thereby causing an imbalance in sharing the entire bandwidth. Thus, detecting the heavy load-flow is the most important thing of all.

The flow detector 20 classifies a flow management space into many spaces to perform the management thereof, and detects a heavy load-flow in the flow management space. For example, the flow detector 20 classifies the flow management space into a space for managing the heavy load-flow and a space for managing a normal flow so as to perform the management thereof. The heavy load-flow refers to the one that is generated during a long period and has a large amount of traffic, whereas the general flow is the one that is generated during a short period.

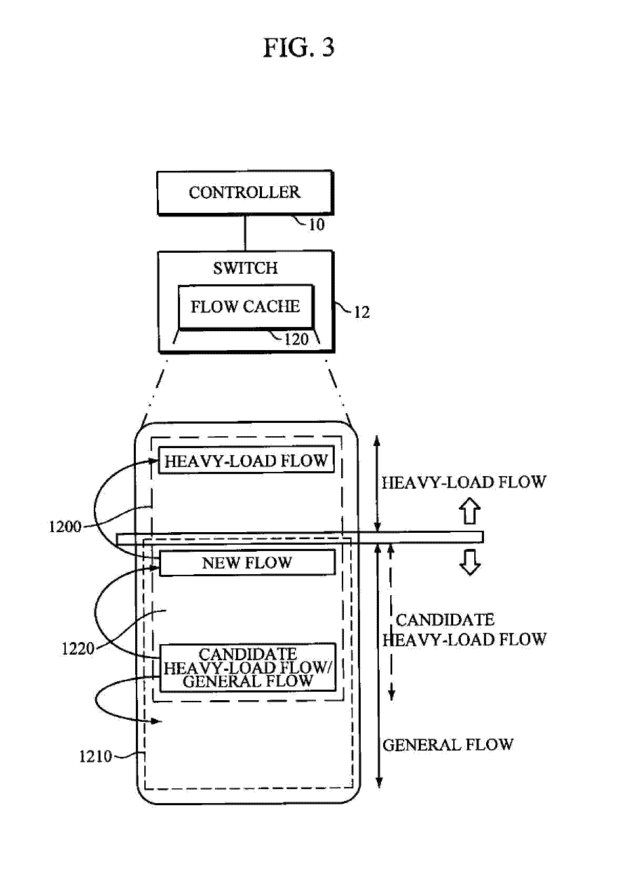

The flow detector 20 variably adjusts the flow management space. For example, the flow detector 20 variably adjusts a switch's flow cache space, which is the limited flow management space, based on a control traffic processing overhead, such as an average time of a flow processing delay or an average amount of the processed flows with respect to the flow stored in the controller's switch, and based on a size of the limited management space of the switch, thereby improving the detection performance of the heavy load-flow. Hereinafter, the flow management space will be described as being limited to the flow cache space of the switch. However, examples of the flow management space are not limited thereto. Examples for detecting the heavy load-flow, executed by the flow detector 20, will be specifically described later with reference to FIG. 3.

The flow transmitter 22 dynamically configures a forwarding path, inside a network, for transmitting the flow detected by the flow detector 20. A data center network has a problem of high operating expenses, caused by inefficient power consumption, and a problem of a possibility of the congestion occurring due to a static path selection method. To solve these problems, the flow transmitter 22 dynamically controls the forwarding path according to each flow by using the SDN technology.

The flow transmitter 22 differentiates path controlling according to characteristics of each classified flow, for example, a heavy load-flow and a general flow. For the detected heavy load-flow, the flow transmitter 22 balances the traffic through multi-path routing. Through a dynamic application of the path controlling differentiated according to the characteristics of each flow, the flow transmitter 22 maintains a load balance of the traffic being transmitted into the entire operating network.

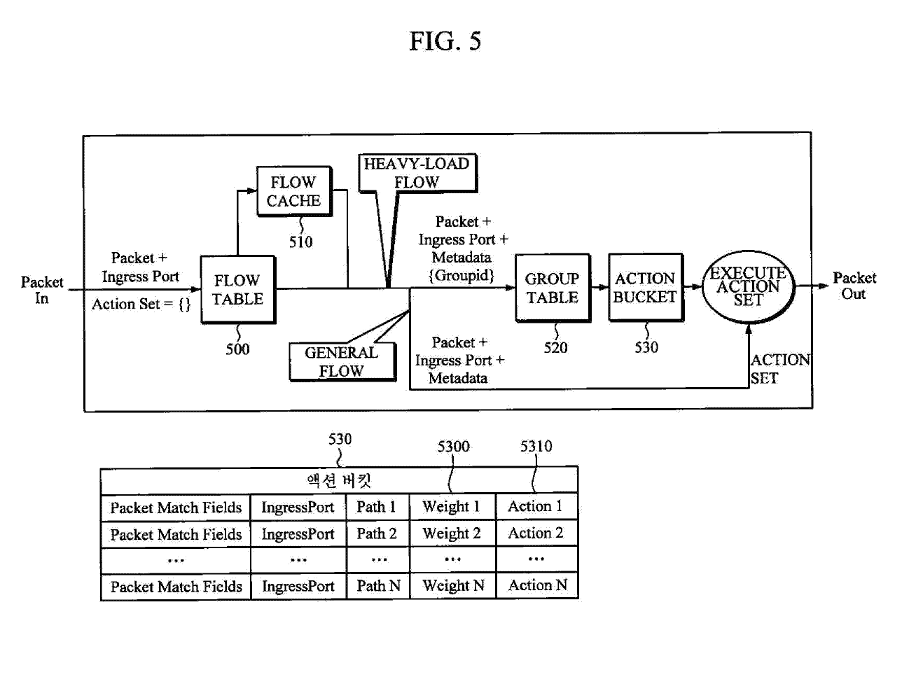

The flow transmitter 22 may calculate a weight according to each forwarding path based on a processed overhead of a controller, and then perform the multi-path routing based on the calculated weight. The flow transmitter 22 may lower the traffic congestion due to the balancing of a network traffic load through the multi-path routing. Moreover, the flow transmitter 22 may improve a percentage of the network resources being used by, with the same network resources, accommodating more traffic. Detailed examples for the multi-path routing, performed by the flow transmitter 22, will be described later with reference to FIG. 5.

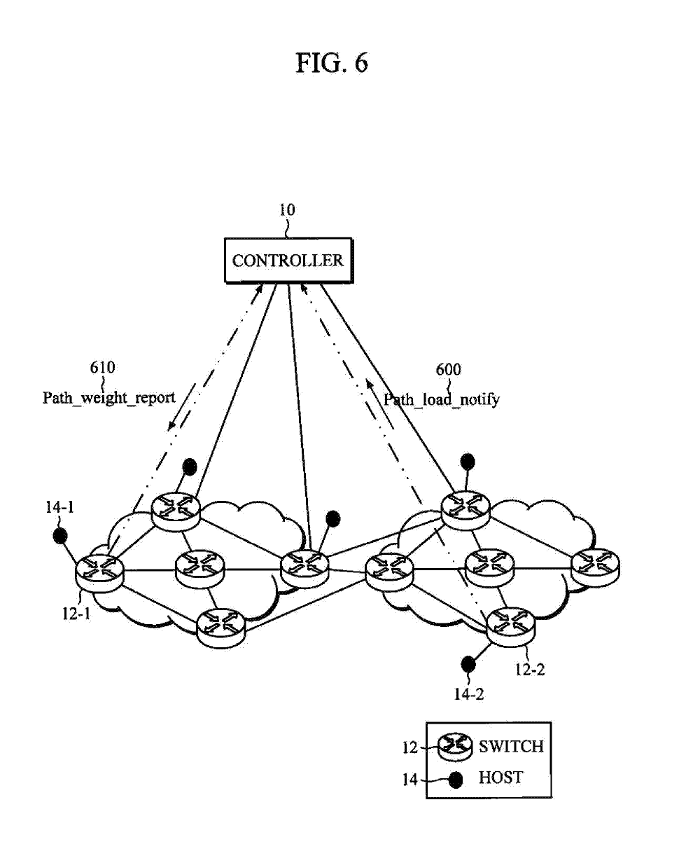

When a flow is transmitted to an output edge switch through the multi-path routing, the path information updater 24 receives a control message, which includes load information of each path, from the output edge switch. Then, using the received load information of each path, the path information updater 24 re-calculates a weight of each path, and then transmits a control message to the relevant switches so as to update the weight information of a group table. A process for, by the path information updater 24, updating the path weight will be specifically described later with reference to FIG. 6.

FIG. 3 is a diagram illustrating a structure of a flow cache inside a switch, for description of a process for detecting a heavy load-flow.

Referring to FIG. 3, a caching technique of least recently used (Hereinafter referred to as ‘LRU’) is used to solve a switch's space problem of ternary content-addressable memory (TCAM). Through an additional application of an effluent caching mechanism, a heavy load-flow is detected.

First, according to a general LRU caching technique, the first flow entry comes in to the top of a flow cache. When a cache miss occurs for the flow that comes next, the relevant flow entry comes in to the top of the flow cache, and the pre-existing flow entry on the top goes down one block. In comparison, when the incoming flow already exists in the flow cache, which causes a cache hit, a packet count of the relevant flow entry is updated, which is then moved to the top of the flow cache. In a case of the full flow cache, the flow entry on the bottom is discarded from the flow cache. Through these processes as above, the duration for heavy load-flow information to be maintained inside the flow cache increases. However, in a case of a network environment which has a large percentage of general flows, there is a concern that although a specific flow is in practice a heavy load-flow, the specific flow may be quickly removed (discarded) from the flow cache through the packet count before being recognized as a heavy load-flow.

A method and apparatus for controlling and managing a flow according to exemplary embodiments proposes a technology for accurately detecting a heavy load-flow even in a network environment having a lot of general flows, so as to prevent a problem of a heavy load-flow being quickly removed because of a general flow that comes frequently as described above. In one exemplary embodiment, a landmark space 1210 and a heavy load-flow management space 1200 are separately set with respect to a flow cache 120 in a switch 12. A candidate heavy load-flow, similar to a heavy load-flow, is managed in an overlapping space 1220, in which the landmark space 1210 and the heavy load-flow management space 1200 overlap with each other.

The flow entries, which have been generated by the controller 10 and transmitted to the switch 12, are stored in a flow table of the switch 12 as a table form. Here, a predetermined flow entry may be removed due to a timeout mechanism or a lack of the space, etc. When a packet comes in to the switch 12, the switch 12 performs a flow rule lookup to check whether a matching entry for the incoming packet exists in the flow entries of the flow table. Here, if there is no matching entry, which causes a flow table miss, the switch 12 performs a lookup of the flow cache 120.

If a matching entry exists, which causes a cache hit during the lookup process of the flow cache, count information of the relevant matching entry is updated, and the relevant forwarding action is performed. In comparison, if the matching entry does not exist, which causes a cache miss, the switch 12 transmits a packet-in message to a controller 10 to request forwarding action information. In response to this request, the controller 10 transmits, to switches in the forwarding path, flow rule information for transmitting a packet, and the switches receiving new flow rule information insert relevant information to its own flow table or update the relevant information.

During the process of the flow rule lookup, a flow entry newly, coming in to the switch 12, comes in to the top of the land mark space 1210 of the flow cache 120. As the flow is processed, if the count value of the relevant flow entry increases and then reaches a preset threshold, the relevant flow entry is moved to not the landmark space 1210 but the heavy load-flow management space 1200. Since only the heavy load-flow entry is stored in the heavy load-flow management space 1200, the detection for a heavy load-flow, which is relatively more precise than a LRU technique, may be performed.

In response to the addition of the general flow entries that newly comes in, the switch 12 checks whether the flow, existing immediately before the flow entry leaves the bottom of the overlapping space 1220, is a candidate which has a possibility of becoming a heavy load-flow. Here, if the flow is determined to be a candidate heavy load-flow entry, the relevant flow entry is moved to the top of the landmark space 1210 so that an entry management period is additionally extended. Accordingly, a case may be prevented, in which the flow is discarded due to a lack of the measured count value although the flow is actually a heavy load-flow.

How much a size of the landmark space 1210 within the flow cache 120 of the switch 12 is assigned greatly changes a probability of the heavy load-flow being detected. In a case of a network environment where a lot of general flows exist, if the size of the landmark space 1210 is assigned too small, a flow may be deleted quickly from the flow cache 120 before being recognized as a heavy load-flow. Also, due to an increase in processing a flow, which does not exist in the flow cache 120, a flow processing overhead of the controller 10 may occur. Meanwhile, if the size of the landmark space 1210 is assigned too large, an overhead of the controller 10 may be reduced, but it may be difficult for a large amount of the heavy load-flows to be stored.

A method and apparatus for controlling and managing a flow according to exemplary embodiments adjusts a size of the landmark space 1210 of the flow cache 120 according to a flow processing capacity of the controller 10, in terms of the load balancing of the entire network. For example, the method and apparatus therefor adjusts a size of the landmark space 1210 according to a flow processing delay time (propagation delay) of the switch 12 of the controller 10, or the number of requests (packet-in, requests) for processing the control of a packet-in flow of the switch 12, etc. The factors described above may help the determination of a degree of the flow-control processing overhead. Thus, based on the factors described above, the method and apparatus therefor may balance a traffic load for a heavy load-flow while avoiding an increase of the overhead of the controller 10.

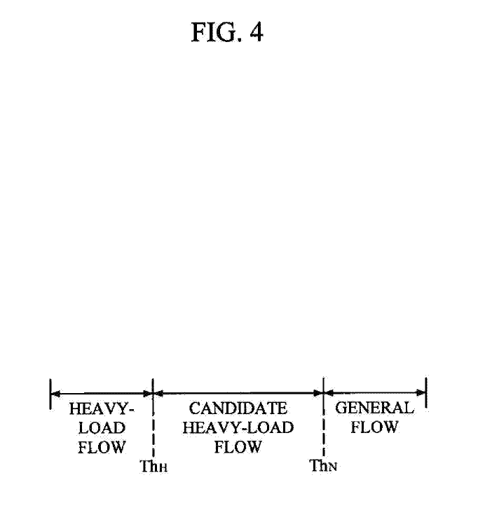

FIG. 4 is a diagram illustrating an example of a flow classification according to a threshold.

Referring to FIG. 4, when a count value for a general flow becomes bigger than a preset threshold (ThN), the relevant flow is determined to be a candidate heavy load-flow. When the count value for the candidate heavy load-flow becomes bigger than a preset threshold (ThH), the relevant flow is determined to be a heavy load-flow. Exceptionally, to prevent a problem of the flow being discarded due to a lack of the measured count value although the flow is actually a heavy load-flow, the candidate heavy load-flow entry positioned on the bottom of an overlapping space of a flow cache is moved to the top of a landmark space so that an entry management period is additionally extended.

Every time the count value reaches a preset threshold, a switch transmits, to a controller, a control message, which sends notification thereof. The controller receiving the notification thereof determines whether the relevant flow is a heavy load-flow, and controls the flow, determined to be a heavy load-flow, to be transmitted through a multi-path forwarding method, thereby balancing a traffic load of a network.

FIG. 5 is a diagram illustrating a table structure for the description of a flow forwarding process for balancing a traffic load.

When a flow generated in a network is classified into a heavy load-flow and a general flow, a controller uses a path weight-based multi-path routing algorithm for a heavy load-flow, which is a flow of interest, through a flow forwarding operation. The path weight-based multi-path routing algorithm is a method for balancing a traffic load, and more specifically, a method for controlling a multi-path so as to dynamically calculate a weight according to each forwarding path and balance and transmit the traffic to the multi-path according to a ratio of the calculated weight.

When a packet comes in to the switch 12 (referred to as ‘packet-in’), the switch 12 performs a flow rule lookup to check whether a matching entry exists in the flow entries of a flow table 500 with regard to the incoming packet The flow table 500 includes a flow entry that defines an action, in which the packet is processed according to a rule (a matching condition). If there is no matching entry, which causes a flow table miss, the switch performs a lookup of the flow cache 510.

For a general flow and a heavy load-flow, a controller applies a differential path forwarding algorithm. For the heavy load-flow, the controller applies a weight-based multi-path routing algorithm. To apply the multi-path routing, the controller generates an entry to form a group table 520 for managing group information that is related to the matching flow, and transmits the generated entry to the switch, which then forms the group table 520 by using the transmitted entry. Each group includes a set of action buckets 530, each of which includes information on a weight 5300 that refers to a percentage of traffic buckets to be processed in a group unit, as well as information on an action set 5310 to be applied to the matching flow. As such, the group table 520 includes information of the action buckets 530 that correspond to paths, where the relevant flow can reach a destination, which means that as the weight of the path is higher, an amount of the loads of the relevant path is weighted small. Thus, the weight of the multi-paths that can transmit the flow may be calculated using the following equation based on a load ratio of each path. In other words, the weight of the path i is calculated through a formula of [1/max L(i, z)]/[Σ(1/max L(i, z))]. Here, L(i, z) refers to a load of each link (i, z) that forms the relevant path i (each link(i, z)εpath(i) among multiple paths).

The calculated path weight is updated at a weight field of each path included in the information of the action buckets that included within a specific group. Based on this, if a hash function with respect to a packet is defined in a switch, a flow may be balanced and transmitted to multi-weighted paths by such a hash function even though the packets, included in the same flow of the same path, are transmitted. Such a path weight may be determined to be a weight that is calculated according to information of the highest load among the loads of links that form a path between input and output edge switches, which is an activated path.

FIG. 6 is a diagram illustrating a network structure for the description of a process for updating a path weight.

Referring to FIGS. 5 and 6, an input edge switch 12-1 first receives a flow packet that a source host 14-1 has transmitted (referred to as ‘packet-in’). The load information of the relevant forwarding path (a path load) is carried on the flow packet and transmitted to a forwarding path, along with information of an identifier (ID) and a port of input and output edge switches 12-1 and 12-2 within a forwarding path, which are determined by a controller 10. Such a transmitted load of a path existing within the flow packet may be updated to the highest-link path load by switches existing within the forwarding path (Path load←Max {eachlink load}).

If the output edge switch 12-2, which is a final terminal, receives the flow packet, the output edge switch 12-2 acquires the path load existing within the received flow packet, carries the load information of the relevant path on a control message (path load_notify) 600, and sends notification thereof to the controller 10. The controller 10, received the control message (path_load_notify) 600, may collect the load information of the paths, to which the flow packet is transmitted, and recalculate a weight of the relevant path based on such load information. The controller 10 transmits a control message (path_weight_report) 610 to the relevant switches so as to update a weight of a group table. Through such control messages 600 and 610 (path_load_notify and path_weight_report), the controller 10 may acquire load information of an activated path, to which the flow packet is transmitted, and on the group table of the relevant switch, update the weight of the multi-path that is calculated based on the load information of the relevant path.

The detected heavy load-flow includes its path weight that is updated in real time according to the load information existing on the path activated by controller through the above-mentioned method, and based on the weight that has been applied when updated, the multi-path routing algorithm is applied, so that the relevant traffic flow is balanced and transmitted according to available resources of the present network.

Using effectively the space of limited memory and the resources inside a switch, a heavy load-flow, which causes an imbalance of the entire bandwidth of the network, may be detected at a high accuracy.

Furthermore, balancing the traffic to the detected heavy load-flow may reduce the network congestion, and accommodate more traffic by using the same network resources, thereby increasing a use rate of the network resources. Also, a network bandwidth may be equally used in terms of the Internet traffic management and services thereof, and problems of the bandwidth management and charging may be solved.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of controlling and managing a flow, the method comprising:
classifying a flow management space into a plurality of spaces, and managing the plurality of spaces;
detecting a heavy load-flow in the classified flow management space; and
adjusting variably a range of the classified flow management space to detect the heavy load-flow.

2. The method of claim 1, wherein the classifying and the managing comprises classifying the flow management space existing within a switch into a first space for managing the heavy load-flow, a second space for managing a general flow entry, and an overlapping space, in which the first and second spaces are overlapped, wherein each flow entry is moved between each space according to a flow cache lookup.

3. The method of claim 2, wherein the classifying and the managing comprises:
managing a heavy load-flow entry in the first space excluding the overlapping space;
managing a candidate heavy load-flow entry in the overlapping space; and
managing the general flow entry in the second space.

4. The method of claim 1, wherein the detecting of the heavy load-flow comprises:
in response to a new flow coming in to the switch, storing an entry of the incoming flow in the second space of the flow management space;
in response to a count value of the flow entry, stored in the second space, increasing to reach a predetermined threshold, determining the flow entry as the heavy load-flow entry and moving the flow entry from the second space to the first space; and
checking whether the flow entry is a candidate heavy load-flow entry immediately before the flow entry leaves the overlapping space, where the first space and the second space overlap, after the flow entry gradually comes down to a bottom of the second space with new incoming flow entries being added, and in response to the flow entry being determined to be the candidate heavy load-flow entry, moving the flow entry to a top of the second space, and extending the entry management period.

5. The method of claim 1, wherein the adjusting variably of the range comprises:
adjusting variably a size of the flow management space according to a flow processing delay time or a flow processing rate with respect to the switch of the controller.

6. The method of claim 1, wherein the adjusting variably of the range comprises:
adjusting a size of the flow management space according to a number of flow processing requests the switch transmits to the controller.

7. A method of controlling and managing a flow, the method comprising:
detecting a heavy load-flow; and
transmitting the detected heavy load-flow according to a weight of each forwarding path through multi-path routing, and balancing traffic.

8. The method of claim 7, wherein the balancing of the traffic comprises:
calculating the weight of each forwarding path for transmitting a flow with respect to the heavy load-flow; and
transmitting the heavy load-flow according to a ratio of the calculated weight of each forwarding path through the multi-path routing.

9. The method of claim 8, wherein the calculating of the weight comprises:
calculating weights of forwarding paths based on a load ratio of each link forming the forwarding path.

10. The method of claim 7, further comprising:
forming a group table for managing group information, related to a matching flow, for the multi-path routing, wherein each group table includes a set of group action buckets, each of which includes information on a weight that refers to a percentage of traffic buckets to be processed in a group unit, as well as information on an action set to be applied to the matching flow.

11. The method of claim 7, further comprising:
in response to a flow being transmitted to an output edge switch through the multi-path routing, receiving a control message, which includes load information of each path, from the output edge switch; and
recalculating the weight of each path by using the received load information, and transmitting a control message to output edge switches, in which the weight of each path is recalculated, so as to update the weight of the group table.

12. The method of claim 11, wherein the load information of each path is updated to a maximum value among loads of each link forming a path by switches existing within the forwarding path.

13. An apparatus for controlling and managing a flow, the apparatus comprising:
a processor, which comprises a flow detector configured to classify a flow management space into a plurality of spaces, detect a heavy load-flow in the classified flow management space, and adjust variably the flow management space.

14. The apparatus of claim 13, wherein the flow detector is configured to classify the flow management space existing within a switch into a first space for managing the heavy load-flow, a second space for managing a general flow entry, and an overlapping space, in which the first and second spaces are overlapped, wherein each flow entry is moved between each space according to a flow cache lookup.

15. The apparatus of claim 14, wherein the flow detector is configured to:
manage a heavy load-flow entry in the first space excluding the overlapping space;
manage a candidate heavy load-flow entry in the overlapping space; and
manage the general flow entry in the second space.

16. The apparatus of claim 13, wherein the flow detector is configured to adjust a size of the flow management space according to a flow processing delay time or a flow processing rate with respect to a switch of a controller, or according to a number of flow processing requests the switch transmits to the controller.

17. The apparatus of claim 13, wherein the processor further comprises:
a flow transmitter configured to transmit the detected heavy load-flow according to a weight of each forwarding path through multi-path routing, and balance traffic.

18. The apparatus of claim 17, wherein the flow transmitter is configured to calculate a weight of each forwarding path based on a load ratio of each forwarding path, and transmit the heavy load-flow according to a ratio of the calculated weight of each forwarding path through the multi-path routing.

19. The apparatus of claim 17, wherein the flow transmitter is configured to form a group table for managing group information, related to a matching flow, for the multi-path routing, wherein each group table includes a set of group action buckets, each of which includes information on a weight that refers to a percentage of traffic buckets to be processed in a group unit, as well as information on an action set to be applied to the matching flow.

20. The apparatus of claim 13, wherein the processor is configured to:
in response to a flow being transmitted to an output edge switch through the multi-path routing, receive a control message, which includes load information of each path, from the output edge switch; and
recalculate a weight of each path by using the received load information, and transmitting a control message to output edge switches, in which the weight of each path is recalculated, so as to update the weight of the group table.
